(19) United States
(12) Patent Application Publication
(10) Pub. No.: US 2015/0044436 A1
(43) Pub. Date: Feb. 12, 2015

(54) METAL COMPOSITE AND METHOD OF PREPARING THE SAME

(71) Applicant: BYD Company Limited, Shenzhen, Guangdong (CN)

(72) Inventor: Aihua Li, Shenzhen (CN)

(21) Appl. No.: 14/385,736

(22) PCT Filed: Mar. 1, 2013
(86) PCT No.: PCT/CN2013/072043

§ 371 Date: Sep. 16, 2014

(30) Foreign Application Priority Data
Mar. 20, 2012 (CN) 201210073788.X

(51) Int. Cl. C25D 11/18; C25D 11/26; B05D 3/12; C25D 11/24; B05D 5/06; B05D 7/14; C25D 11/30; C25D 11/04

(52) U.S. Cl. CPC C25D 11/18; C25D 11/30; C25D 11/26; C25D 11/04; C25D 11/243; C25D 11/246; B05D 5/06; B05D 7/14; B05D 3/12
USPC 428/209; 428/469; 427/264

(57) ABSTRACT

A method of preparing a metal composite material comprises: providing a metal substrate having an anodic oxidation layer on a surface thereof; forming a first dyed layer on the anodic oxidation layer; forming a second dyed layer on the first dyed layer; and removing at least a part of the second dyed layer. A metal composite material is also provided.

### CROSS-REFERENCE TO RELATED APPLICATION

This application claims priority to and benefits under 35 U.S.C. §371 of International Patent Application No. PCT/CN2013/072043, having an international filing date of Mar. 1, 2013, and entitled “METAL COMPOSITE MATERIAL AND METHOD OF PREPARING THE SAME,” which claims priority to and benefits of Chinese Patent Application No. 201210073788.X, filed with the State Intellectual Property Office of P. R. China on Mar. 20, 2012. The entire contents of these applications are hereby incorporated by reference.

### FIELD

The present disclosure relates to the field of surface treatment, more particularly to a metal composite material, and method of preparing the same.

### BACKGROUND

The statements in this section merely provide background information related to the present disclosure and may not constitute prior art.

Al alloys comprising a porous anodic oxidation layer have good adsorption properties for dyestuffs. Traditional process of preparing colorful dyed layers on an anodized metal substrate mainly uses a dyeing method. However, the dyed layer formed by traditional dyed methods only has a single color.

### SUMMARY

This summary is provided to introduce a selection of concepts in a simplified form that are further described below in the section of DETAILED DESCRIPTION. This summary is not intended to identify key features or essential features of the claimed subject matter, nor is it intended to be used as an aid in determining the scope of the claimed subject matter.

The present invention seeks to solve at least one of the problems existing in the prior art to at least some extent. To this end, an object of the present invention is to provide a method of preparing a metal composite material. The method may comprise the steps of: providing a metal substrate having an anodic oxidation layer on a surface thereof; forming a first dyed layer on the anodic oxidation layer; forming a second dyed layer on the first dyed layer; and removing at least a part of the second dyed layer.

In an embodiment of present disclosure, the method of preparing the metal composite material comprises the steps of: S1) a metal substrate is anodic oxidized to form an anodic oxidation layer on a surface of the metal substrate; S2) the metal substrate obtained from step S1) is firstly dyed to form a first dyed layer on the anodic oxidation layer; S3) the metal substrate obtained from step S2) is secondly dyed to form a second dyed layer on the first dyed layer; S4) at least a part of the second dyed layer is removed to form a pattern; S5) holes in the metal substrate obtained from step S4) are sealed.

Another object of the present invention is to provide a metal composite material. The metal composite material may comprise: a metal substrate; an anodic oxidation layer formed on a surface of the metal substrate; a first dyed layer formed on the anodic oxidation layer; and a second dyed layer formed on at least a part of the first dyed layer.

In an embodiment of present disclosure, the metal composite material comprises: a metal substrate having an anodic oxidation layer on a surface thereof; a first dyed layer formed on the anodic oxidation layer, and having a pattern area thereon; and a second dyed layer formed on the pattern area of the first dyed layer.

With the method of preparing the metal composite material according to the present disclosure, an anodic oxidation layer may be formed on the surface of the metal substrate, the first and second dyed layers may be formed on the anodic oxidation layer, at least a part of the second dyed layer is removed to expose at least a part of the first dyed layer to form a pattern, and holes in the obtained metal substrate may be sealed. As the first and second dyed layers may have different colors, layers having different colors may be formed on the metal substrate. The method according to present disclosure is simple in process, easy to operate, and low in energy consumption. Accordingly, the first and second dyed layers show excellent resistance to corrosion, wear, and peeling.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions made with reference the accompanying drawing, in which:

FIG. 1 is a flow chart showing the method of preparing the metal composite material according to an embodiment of present disclosure;

FIG. 2 is a top view of the metal composite material according to an embodiment of the present disclosure; and

FIG. 3 is a side view of the metal composite material of FIG. 2.

### DETAILED DESCRIPTION

Reference will be made in detail to embodiments of the present disclosure, and examples of described embodiments are indicated in the drawings. The embodiments described herein with reference to drawing are explanatory, illustrative, and used to generally understand the present disclosure. The embodiments shall not be construed to limit the present disclosure.

According to a first aspect of the present disclosure, there is provided a method of preparing a metal composite material. The method may comprise the steps of: providing a metal substrate having an anodic oxidation layer on a surface thereof; forming a first dyed layer on the anodic oxidation layer; forming a second dyed layer on the first dyed layer; and removing at least a part of the second dyed layer.

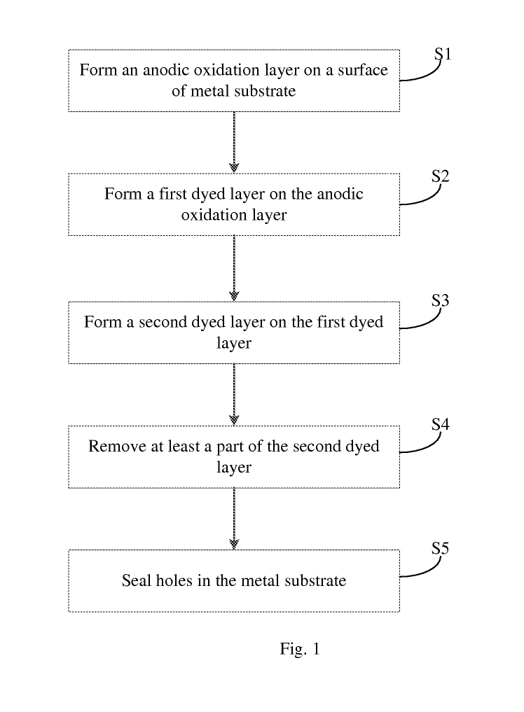

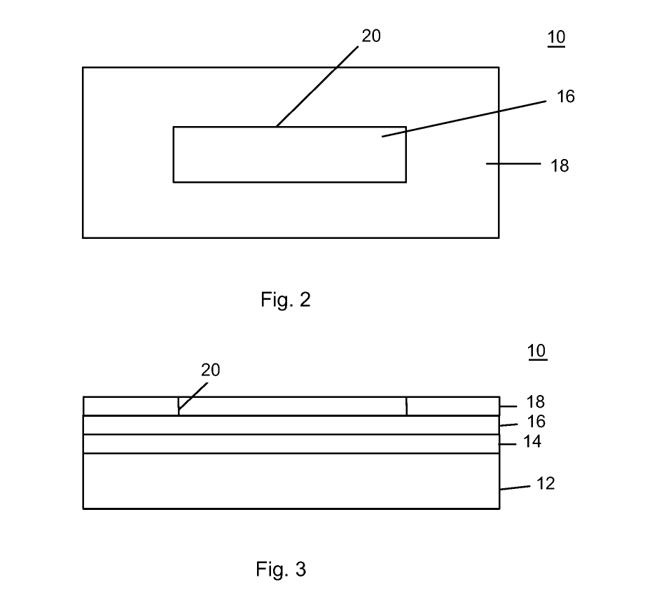

In an embodiment of present disclosure, as shown in Figs.1 to 3, the method of preparing the metal composite material 10 comprises the steps of: S1) a metal substrate 12 is anodic oxidized to form an anodic oxidation layer 14 on a surface of the metal substrate 12; S2) the metal substrate 12 formed with the anodic oxidation layer 14 is firstly dyed to form a first dyed layer 16 on the anodic oxidation layer 14; S3) the metal substrate 12 formed with the first dyed layer 16 is secondly dyed to form a second dyed layer 18 on the first dyed layer 16; S4) at least a part 20 of the second dyed layer 18 is removed to form a pattern; S5) holes in the metal substrate formed with the anodic oxidation layer, the first and second dyed layers are sealed.

In an embodiment of present disclosure, the metal substrate comprises at least one selected from a group consisting of: Al, Ti, Mg, Al alloy, Ti alloy, and Mg alloy. The metal substrate may be any common metal substrate which could be anodized to form a porous anodic oxidation layer on a surface thereof.

In an embodiment of present disclosure, the metal substrate having an anodic oxidation layer may be pretreated before the anodic oxidation layer is formed. The pretreatment can be selected from any well-known methods in the art, for example, polishing, paraffin removing, oil removing, alkali corrosion and the like.

The anodic oxidation layer can be formed by any known method in the art. In an embodiment of present disclosure, the anodic oxidation layer is formed using the metal substrate as an anode, and the electrolyte solution as the cathode. Thus, the metal substrate is anodized by the electrolyte solution. In an embodiment of present disclosure, the electrolyte solution may be at least one selected from the group of sulfuric acid, chromic acid, and oxalic acid.

In an embodiment of present disclosure, the anodic oxidation layer can be formed by the following steps: the metal substrate is immersed into a sulfuric acid solution having a concentration of about 160 g/l to about 200 g/l, then anodized for about 30 min to about 60 min under a voltage of about 10 Volts to about 18 Volts and a current of about 0.5 A/dm² to about 2.5 A/dm². In that way, the anodic oxidation layer may have more porosity, and better corrosion and wear resistances.

In some embodiments of present disclosure, the first dyed layer is formed by using a first dye solution comprising a first dyestuff, and the second dyed layer is formed by using a second dye solution comprising a second dyestuff. The first dyed layer and the second dyed layer may be formed on the anodic oxidation layer via any conventional dyeing process. In an embodiment, the metal substrate formed with the anodic oxidation layer is immersed into a first dye solution comprising a first dyestuff to prepare the first dyed layer, and the metal substrate formed with the first dyed layer is immersed into a second dye solution comprising a second dyestuff to prepare the second dyed layer. There are no special limits for the first and second dyestuffs, any dyestuffs or dye solution which can fill in the holes of the anodic oxidation layer, the first and second dyed layers can be adapted.

In an embodiment of present disclosure, the time of forming the first dyed layer only requires to form a proper first dyed layer. It might influence the effect of the second dyed layer if the time of forming the first dyed layer is too long. It is known to one with ordinary skills in the art that different dyestuffs may require different dyeing processes, thus the time of forming the first dyed layer depends on the types of dyestuffs.

In an embodiment, the first dyestuff and the second dyestuff are of a same type, and the first dyestuff and the second dyestuff may be of a different concentration. For example, the first dyestuff in the first dye solution is TAC Brownze having a concentration of about 1.5 g/l, and the second dyestuff in the second dye solution is Brownze having a concentration of about 10 g/l. Thus, two or more dyed layers having a same color but different in aberration can be formed on the metal substrate or anodic oxidation layer of the metal substrate.

In an embodiment, the first dyestuff and the second dyestuff are of a different type. In order to form a metal composite material having a dyed layer which is colorful and classic in the appearance, the first dyestuff and the second dyestuff according to an embodiment of present disclosure are of a different type. In other words, components in the first dye solution may be different from those in the second dye solution. For example, the first dyestuff in the first dye solution is TAC Brownze, and the second dyestuff in the second dye solution is TAC Black-GLH.

In an embodiment of present disclosure, at least a part of the second dyed layer is removed by means of polishing. A predetermined part of the second dyed layer may be removed to expose at least a part of the first dyed layer, then the remaining part of the second dyed layer together with the first layer form a pattern on the anodic oxidation layer of the metal substrate.

In an embodiment of present disclosure, the polishing is carried out by means of at least one of buffing, barrel burnishing, lapping, grinding, and combinations thereof. There are no special limits on the polishing, and the polishing may be carried out by any conventional method which removes at least a part of the second dyed layer. In an embodiment of present disclosure, the metal substrate is polished to remove a part of the second dyed layer and expose a part of the first dyed layer, thus the remaining parts of the second dyed layer and the first dyed layer may exhibit a colorful or classic effect.

In an embodiment of present disclosure, the removing step may be carried out on at least a part of the metal substrate so as to provide the metal substrate with different colors (a color in the removed area has the color of the first dyed layer and another color in the non-removed area has the color of the second dyed layer). Alternatively, the removing step may be carried out by a polishing machine, the computer program of which controls the operation of the polishing machine or the movement of the metal substrate. Thus, the metal substrate having the anodic oxidation layer may be polished along a predetermined pattern or a predetermined path to form a predetermined pattern on the metal substrate or on the anodic oxidation layer of the metal substrate. In an embodiment, the method of preparing the metal composite material may further comprise a step of sealing holes.

In an embodiment of present disclosure, the step of sealing holes is carried out using at least one of hot water, steam and hydrolyzed salt. The sealing process for sealing holes may be any conventional hole-sealing process, without limit. In the step of sealing holes using hot water or steam, water may be filled in the micropores of the anodic oxidation layer, the first dyed layer, and the second dyed layer, then hydration products, such as hydration ions, may be formed to seal holes thereof. In the step of sealing holes using hydrolyzed salts, the metal substrate formed with the anodic oxidation layer is immersed into a hydrolyzed salt solution, then the anodic oxidation layer may be subjected to a hydrodation reaction, also hydrates or metal ions generated from the hydrolyze of the salt may react with the dyestuffs so as to form a metal complex which may settle in the micropores of the anodic oxidation layer, the first dyed layer, and the second dyed layer, then effect the step of sealing holes. The method is known to those with ordinary skills in the art, so that the detailed descriptions thereof are omitted herein.

In an embodiment of present disclosure, the step of sealing holes is carried out after the step of removing at least a part of the second dyed layer.

In an embodiment of present disclosure, the step of sealing holes is carried out prior to the step of removing at least a part of the second dyed layer, and after the step of forming a second dyed layer on the first dyed layer. With the present step of sealing holes, the spilling of dyestuffs absorbed in the micropores or holes of the anodic oxidation layer, the first dyed layer and the second dyed layer during the polishing steps can be prevented, thus the color unevenness of bad surface effect can be avoided.

In an embodiment of present disclosure, the method further comprises a step of forming a protective layer. The protective layer may be formed on the metal substrate, exposed part of the first layer, or the second dyed layer. With the protective layer, the life of the first and second dyed layers may be prolonged. In an embodiment, the protective layer is carried out via spray coating. For example, spray coating protective paints onto the metal substrate to form a protective layer.

According to embodiments of the present disclosure, a metal composite material is also provided which comprises: a metal substrate; an anodic oxidation layer formed on a surface of the metal substrate; a first dyed layer formed on the anodic oxidation layer; and a second dyed layer formed on at least a part of the first dyed layer.

In an embodiment of present disclosure, the metal composite material comprises: a metal substrate having an anodic oxidation layer on a surface thereof; a first dyed layer formed on the anodic oxidation layer, and having a pattern area thereon; and a second dyed layer formed on the pattern area of the first dyed layer.

In an embodiment of present disclosure, the second dyed layer forms a pattern together with the first dyed layer.

The disclosure will be further described below in way of examples. Raw materials used in Examples and Comparative Examples are all commercially available.

### EXAMPLE 1

A metal composite material is prepared in a method comprising the following steps:

(1) Pretreatment

An Al alloy substrate was immersed in a TH-60 degreasing agent solution having a concentration of 50 g/l at 65 degrees Celsius for 2 min. The Al alloy substrate after the degreasing was corroded in a NaOH solution having a concentration of 40 g/l at 45 degrees Celsius for 10 s, and then removed from the NaOH solution and cleaned with water. The cleaned Al alloy substrate was immersed in a 30% HNO₃ solution at room temperature for 10 s, and then removed from the HNO₃ solution and cleaned with water.

(2) Anodic Oxidation

The Al alloy substrate after the step of pretreating was immersed in a H₂SO₄ solution having a concentration of 190 g/l for 40 min under a voltage of 14 Volt and a current of 1 A/dm², and then removed from the H₂SO₄ solution and cleaned with water.

(3) Forming First Dyed Layer

The Al alloy substrate after the step of anodic oxidation was immersed in a first dye solution comprising 1.5 g/l TAC Brownze (commercially available from OKUNO NEW TECHNOLOGY INDUSTRIES (HANGZHOU) CO., LTD.) at 55 degrees Celsius for 30 s to form a first dyed layer.

(4) Forming Second Dyed Layer

The Al alloy substrate formed with the first dyed layer was immersed in a second dye solution comprising 10 g/l TAC Black-GLH (produced by OKUNO NEW TECHNOLOGY INDUSTRIES (HANGZHOU) CO., LTD.) at 50 degrees Celsius for 2 min to form a second dyed layer upon the first dyed layer.

(5) Removing Second Dyed Layer

The Al alloy substrate formed with the first and second dyed layers was placed on a polisher and waxed by a cotton wheel, then polished with a revolution speed of 1000 r/m, in order to remove a predetermined part of the second dyed layer to expose a part of the first dyed layer.

(6) Sealing Holes

The polished Al alloy substrate was immersed in a 10 g/l DH-500 hole-sealing salt (commercially available from OKUNO NEW TECHNOLOGY INDUSTRIES (HANGZHOU) CO., LTD.) solution at 95 degrees Celsius for 20 min, and removed from the solution and cleaned, then dried in a drier at 60 degrees Celsius for 30 min to obtain a metal composite material.

The surface of the obtained metal composite material has two different colors and aesthetic appearance.

### EXAMPLE 2

This example is carried out in a way substantially the same with Example 1 with the following exceptions: in the step of forming the second dyed layer, the metal substrate formed with the first dye layer was immersed in a second dye solution comprising 10 g/l TAC Brownze (commercially available from OKUNO NEW TECHNOLOGY INDUSTRIES (HANGZHOU) CO., LTD.) at 55 degrees Celsius.

### EXAMPLE 3

This example is carried out in a way substantially the same with Example 1 with the following exceptions: providing a further step of sealing holes between the step of forming the second dyed layer and the step of removing the second dyed layer; in the step of sealing holes after the step of removing the second dyed layer and before the step of removing the second dyed layer, the polished Al alloy substrate was immersed in a 10 g/l DH-500 hole-sealing salt (commercially available from OKUNO NEW TECHNOLOGY INDUSTRIES (HANGZHOU) CO., LTD.) solution at 95 degrees Celsius for 20 min, and removed from the solution and cleaned, then dried in a drier at 60 degrees Celsius for 30 min.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A method of preparing a metal composite material, comprising:
providing a metal substrate having an anodic oxidation layer on a surface thereof;
forming a first dyed layer on the anodic oxidation layer;
forming a second dyed layer on the first dyed layer; and
removing at least a part of the second dyed layer.

2. The method of claim 1, wherein the metal substrate comprises at least one selected from a group consisting of Al, Ti, Mg, Al alloy, Ti alloy, and Mg alloy.

3. The method of claim 1, the first dyed layer is formed by using a first dye solution comprising a first dyestuff, and the second dyed layer is formed by using a second dye solution comprising a second dyestuff.

4. The method of claim 3, wherein the first dyestuff and the second dyestuff are of a same type, and the first dyestuff and the second dyestuff are of a different concentration.

5. The method of claim 3, wherein the first dyestuff and the second dyestuff are of a different type.

6. The method of claim 1, wherein at least a part of the second dyed layer is removed to form a pattern.

7. The method of claim 1, wherein at least a part of the second dyed layer is removed by means of polishing.

8. The method of claim 7, wherein the polishing is carried out by means of at least one of buffing, barrel burnishing, lapping, grinding, and combinations thereof.

9. The method of claim 1, further comprising a step of sealing holes.

10. The method of claim 9, wherein the step of sealing holes is carried out after the step of removing at least a part of the second dyed layer.

11. The method of claim 9, wherein the step of sealing holes is carried out prior to the step of removing at least a part of the second dyed layer, and after the step of forming a second dyed layer on the first dyed layer.

12. The method of claim 9, wherein the step of sealing holes is carried out using at least one of hot water, steam, and hydrolyzed salt.

13. A metal composite material comprising:
a metal substrate;
an anodic oxidation layer, formed a surface of the metal substrate;
a first dyed layer, formed on the anodic oxidation layer; and
a second dyed layer, formed on at least a part of the first dyed layer.

14. The metal composite material of claim 13, wherein the second dyed layer forms a pattern together with the first dyed layer.

15. The metal composite material of claim 13, wherein the second dyed layer is in direct contact with a part of a top surface of the first dyed layer and a remaining part of the top surface of the first dyed layer is exposed from the second dyed layer.

16. The metal composite material of claim 13, wherein the first dyed layer is disposed between and in direct contact with the anodic oxidation layer and the second dyed layer.

17. The method of claim 1, wherein the step of forming a second dyed layer on the first dyed layer includes depositing the second dyed layer on an entire top surface of the first dyed layer.

18. The method of claim 1, wherein the step of removing at least a part of the second dyed layer includes removing only a part of the second dyed layer to expose a part of the first dyed layer.

19. The method of claim 1, wherein the first dyed layer is in direct contact with the anodic oxidation layer and the second dyed layer.

20. The method of claim 9, wherein the step of sealing holes includes sealing holes in an entire surface of the metal composite material.
